(19) United States
(12) Patent Application Publication
(10) Pub. No.: US 2016/0196104 A1
(43) Pub. Date: Jul. 7, 2016

(54) Programmable Audio Device

(71) Applicant: Zachary Paul Gordon, Berrien Springs, MI (US)

(72) Inventor: Zachary Paul Gordon, Berrien Springs, MI (US)

(21) Appl. No.: 14/976,658

(22) Filed: Dec. 21, 2015

Related U.S. Application Data
(60) Provisional application No. 62/100,893, filed on Jan. 7, 2015.

(51) Int. Cl. G06F 3/16

(52) U.S. Cl. CPC G06F 3/165

(57) ABSTRACT

Disclosed is a method of operation of a programmable audio device. The method includes: (a) initializing and starting a countdown timer; (b) playing a stored audio file; (c) determining if the countdown timer has elapsed and, if not, continue playing the stored audio file until the countdown timer elapses; (d) in response to the countdown timer elapsing, pause playing the audio file and play a message file; and (e) following step (d), continue playing the paused audio file.

### CROSS-REFERENCE TO RELATED APPLICATION

This application claims the benefit of U.S. Provisional Patent Application No. 62/100,893, filed Jan. 7, 2015, entitled “Patient Comfort Device”.

### BACKGROUND OF THE INVENTION

1. Field of the Invention

Disclosed herein is a programmable audio device. In an example, the programmable audio device can be utilized for comforting patients with cognitive mental disorders, such as dementia.

2. Description of Related Art

Current treatment devices for patients that have cognitive mental disorders, such as dementia, include safety devices that alert staff of a patient's change in position, but do not prevent such movements in position, which can be dangerous. These safety devices can include audio alarms or messages that are generated in response to the patient's change in position. Moreover, medications are often utilized to avoid patients from changing positions, e.g., from being seated to standing, where standing is not desired due to the patient's physical inability to stand.

### SUMMARY OF THE INVENTION

Various preferred and non-limiting examples or aspects of the present invention will now be described and set forth in the following numbered clauses:

Clause 1: A method of operation of a programmable audio device comprising: (a) initializing and starting a countdown timer; (b) playing a stored audio file; (c) determining if the countdown timer has elapsed and, if not, continue playing the stored audio file until the countdown timer elapses; (d) in response to the countdown timer elapsing, pause playing the audio file and play a message file; and (e) following step (d), continue playing the paused audio file.

Clause 2: The method of clause 1, wherein step (d) includes delaying the pause and playing the audio file until the end of the audio file.

Clause 3: The method of clause 1 or 2, further including repeating steps (a)-(e) at least once.

Clause 4: The method of any one of clauses 1-3, wherein the countdown timer elapses when the value of the countdown timer decrements to zero.

### BRIEF DESCRIPTION OF THE DRAWING(S)

FIG. 1 is a schematic block diagram of example electrical hardware elements comprising the example programmable audio device described herein;

FIGS. 2 and 3 are perspective front and back views of an example housing for housing the electrical hardware elements shown in FIG. 1; and

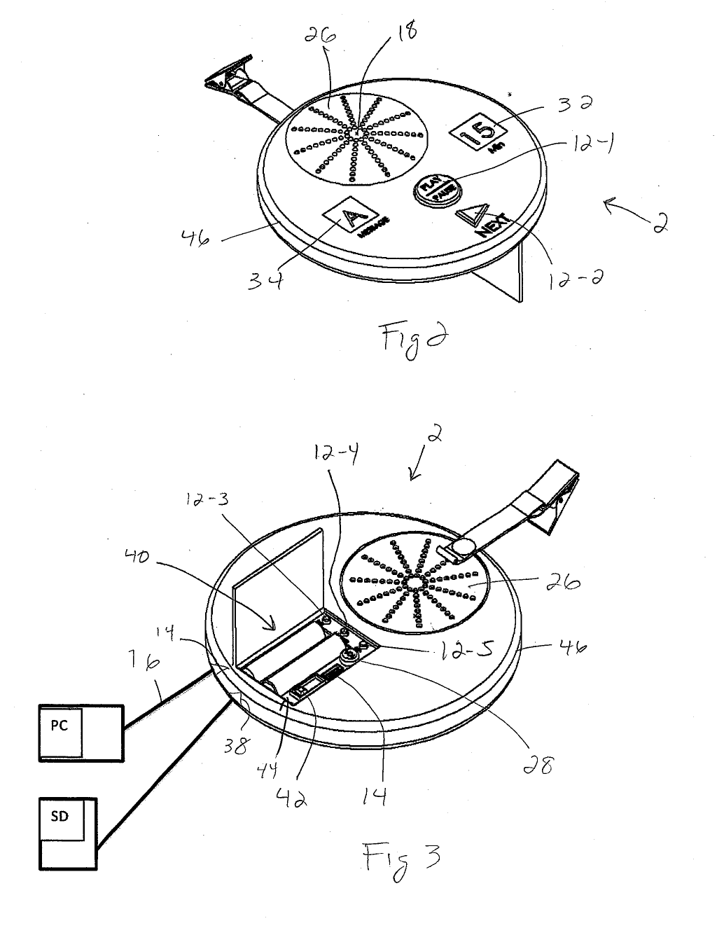

FIG. 4 is a flow diagram of a method of operating the example programmable audio device shown in FIGS. 1-3.

### DESCRIPTION OF THE INVENTION

An exemplary embodiment will be described with reference to the accompanying figures where like reference numbers correspond to like elements.

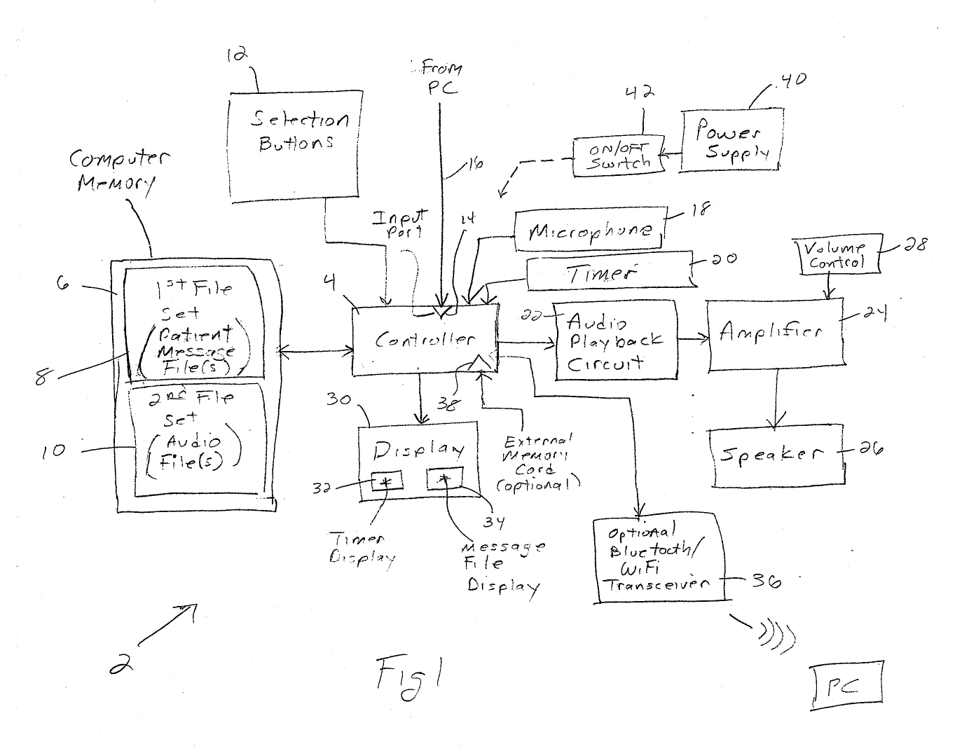

With reference to FIG. 1, there is shown a schematic block diagram of an example programmable audio device 2, which includes the controller 4 for controlling the operations of device 2 described hereinafter. Controller 4 can be any suitable and/or desirable type of controller, including, without limitation, a microprocessor that operates under the control of an embedded control program. The description of controller 4 being a microprocessor operating under the control of an embedded control program, however, is not to be construed in a limiting sense since it is envisioned that controller 4 can comprise any suitable and/or desirable programmable hardware that facilitates the functions described hereinafter.

Device 2 also includes computer memory 6, e.g., without limitation, EPROM, coupled to controller 4. Memory 6 can be configured to store digital files (e.g., audio files and message files) in a manner known in the art. In an example, memory 6 can store a first file set comprising one or more message files, and a second file set 10 comprising one or more audio files. The audio files can comprise one or more of the following: music files, audio of a television or radio broadcast, an audio reading of a book, and/or any other suitable and/or desirable file. The message files can comprise one or more customized audio message selected for the user of the device 2, e.g., a dementia patient.

While the first and second file sets 8 and 10 are shown as being separate segments of computer memory 6, this is not to be construed as limiting since it is envisioned that files of the first set of files 8 and the files of the second set of files 10 can be distinguished from each other in any suitable and/or desirable manner. In an example, the first set of files 8 can be stored in a first part of computer memory 6 while the second set of files 10 can be stored in a second, separate part of computer memory 6. In another example, each file of the first set of files 8 can be tagged with an appropriate information that distinguishes said file from files of the second set of files 10 which can be tagged with different information. In an example, the distinguishing information used to tag each file can comprise header information, footer information, and/or a unique digital sequence appended to each file. However, this not to be construed as in a limiting sense.

Device 2 also includes selection buttons 12 coupled to controller 4 and usable by a user of device 2 for programming the operation of device 2 in a manner to be described hereinafter. Selection buttons 12 can include a play/pause button 12-1; a next button 12-2; a record button 12-3; a message select button 12-4; and a minute button 12-5.

Controller 4 also includes an input port 14, such as a USB port or any other suitable and/or desirable computer port that facilitates connection of controller 4 to an external computing device, such as a PC, via a wired connection (cable) 16.

Device 2 also includes a microphone 18 and a timer or clock circuit 20 coupled to controller 4. An audio playback circuit 22 is operative for decoding each digital file received from computer memory 6 via controller 4 into a low level analog equivalent signal which audio playback circuit 22 provides to amplifier 24 which converts the low level analog signal into a high level analog signal which amplifier 24 supplies to a speaker 26 which converts the high level analog output of amplifier 24 into a human perceivable audio signal in a manner known in the art. A volume control 28 can be coupled to amplifier 24 for controlling the amplitude of the high level signal output by amplifier 24 to speaker 26 in a manner known in the art.

Controller 4 can be coupled to a display 30 which, under the control of controller 4, can display any suitable and/or desirable information that facilitates use of device 2 by a user thereof. In an example, display 30 can include a timer display 32 and/or a message file display 34. However, this is not to be construed in a limiting sense.

Device 2 can include an optional transceiver 36 coupled to controller 4 for enabling wireless download of files of the first set of files 8 and/or the second set of files 10 into computer memory 6 via controller 4. In an example, transceiver 36 can be a Bluetooth transceiver, a Wi-Fi transceiver, or a combined Bluetooth/Wi-Fi transceiver. However, is not to be construed in a limiting sense since it is envisioned that transceiver 36 can implement any suitable and/or desirable wireless protocol(s), now known or hereinafter developed, that can be utilized for downloading files into computer memory 6.

Controller 4 can include an optional memory card slot 38 configured to receive an external memory card, such as an SD card. This memory card can be programmed with one or more files of the first set of files 8 and/or the second set of files 10 to be downloaded onto computer memory 6 via controller 4. Finally, a power supply 40, for example, single-use-only batteries or rechargeable batteries, can be included in a batteries slot 44 of a housing 46 of device 2 to provide DC power to the various electrical hardware elements of device 2 that consume electrical power during use. Device 2 can include an on/off switch 42 that can be selectively switched to a closed state to enable electrical power from power supply 40 to be supplied to the various electrical hardware elements of device 2 that consume electrical power during use, or to an open state, to isolate the various electrical hardware elements of device 2 that consume electrical power during use from power supply 40.

Having thus described the example programmable audio device 2, use of device 2 will now be described.

At a high level, with power being supplied to device 2 from power supply 40, device 2 is operative for continuously playing one or more audio files from the second file set 10, either sequentially or in random order, until interrupted on a programmed schedule to play a message file from the first file set 8. More specifically, in an example, starting from a state with power applied to device 2 and in response to a first activation of play/pause button 12-1, controller 4 causes audio files from the second file set 10 to be played, either sequentially or in random order, on speaker 26 until a time programmed into controller 4 and displayed on timer display 32 elapses. Upon this time elapsing, the playing of the current audio file of the second file set 10 is paused or suspended and at least one predetermined message file from the first file set 8, for example the message file associated with the data shown on message file display 34, is played on speaker 26. Once the message file from the first file set 8 has completed playing, controller 4 is operative for causing the paused audio file to commence playing again, in an example, resume playing from the point where it was paused.

Absent play/pause button 12-1 being activated a second time, whereupon the playing of all files is paused until play/pause button 12-1 is activated another time, the process of playing audio files from the second file set 10 and, based on the predetermined interval programmed into controller 4 (and optionally displayed on timer display 32), suspending or pausing the playing of the audio files from the second file set 10 and playing a message file (in an example, related to the data shown on message file display 34) from the first file set 8 is continuously repeated. Upon completion of playing each message file, controller 4 is operative for causing the playing of the paused audio file of the second file set 10 to continue or resume from the point where it was paused. Thus, if playing of an audio file of the second file set 10 was paused halfway through its play duration in order for the message from the first file set 8 to be played, upon completion of the message from the first file set 8, the paused audio file from the second file set 10 resumes playing again from the point it was paused.

In an example, instead of pausing the playing of an audio file of the second file set 10 in order to play a file from the first file set 8 upon expiration of the interval programmed into device 2, controller 4 can be operative for delaying the playing of the file from the first file set 8 until the presently playing file of the second file set 10 is complete. However, this is not to be construed in a limiting sense.

In order to determine when the time interval programmed into device 2 and displayed on timer display 32 has elapsed, controller 4 can implement an internal countdown timer that is initialized a value corresponding the time programmed into device 2 and displayed on timer display 32. Upon activating the play/pause button 12-1, controller 4 commences decrementing the countdown timer and playing audio file(s) from the second file set 10. Upon the value of the countdown timer reaching zero, controller 4 pauses playing of the present audio file from the second file set 10 and plays a message file from the first file set 8 in the manner described above. After, playing the message file, controller 4 reinitializes the countdown timer with the value corresponding to the time programmed into device 2 and displayed on timer display 32, commences decrementing the countdown timer, and resumes playing the audio file that was paused just prior to playing the message file. The decrementing of the countdown timer can begin at the start of playing the message file, at the end of playing the message file, or sometime therebetween. The process of playing a message file based on the time interval programmed into device 2 and playing audio file(s) when the message file is not being played can continue until the play/pause button 12-1 is activated again, the on/off switch 42 is switched to its open state, or power supply 40 is drained.

Pressing play/pause button 12-1 during playing of a file from either the first file set 8 or the second file set 10 pauses playing of the file until the next time play/pause button 12-1 is pressed. In an example, pressing play/pause button 12-1 during playing of a file can also suspend decrementing of the countdown timer until the next time play/pause button 12-1 is pressed. Pressing next button 12-2 when an audio file from the second file set 10 is being played causes controller 4 to commence playing the next, or another audio file, in the second file set 10. In an example, pressing next button 12-2 when a message file is playing can have no effect, namely, in an example, the message file will complete playing until it is complete, whereafter playing of any file is paused until the next time play/pause button 12-1 is pressed. In an example, the value of the countdown timer can be preserved or reset in response to pressing play/pause button 12-1 during playing of a file from either the first file set 8 or the second file set 10. The next time play/pause button 12-1 is pressed, the countdown timer commences decrementing from the preserved or reset value.

In an example, audio files can be programmed into the second file set 10 via a PC coupled to input port 14 via cable 16. In an example, operating under control of the control program, controller 4 can segment computer memory 6 into a first partition for storing the first file set 8 and into a second partition for storing the second file set 10. Upon accessing computer memory 6 via input port 14, a PC can be presented with this partition and the user of the PC can select whether to store a file in the second file set 10 or the first file set 8.

In another example, device 2 can include optional memory card slot 38 for receiving an external memory card that includes files for storage in the first file set 8 or the second file set 10. In this example, the downloading of each file from the memory card into the first file set 8 or the second file set 10 can be managed under the control of the PC connected to controller 4 via input port 14. In another example, each file can include an appropriate tag, header, footer, file name, or file extension that identifies the file as one to be stored in the first file set 8 or the second file set 10. In this latter example, upon insertion of an external memory card into memory card slot 38, controller 4, operating under the control of the control program, can automatically transfer files into the first file set 8 and/or the second file set 10 based on the tag, header, footer, file name, or file extension. In an example, the messages stored in the first file set 8 and/or the second file set 10 can be managed in any suitable and/or desirable manner, for example, by the PC via input port 14. However, this is not to be construed in a limiting sense.

Finally, in another example, device 2 can include an optional wireless transceiver 36 for wirelessly transferring files into the first file set 8 and/or the second file set 10 under the control of a PC via a wireless connection. In an example, transceiver 36 can be a Bluetooth transceiver, a Wi-Fi transceiver, a combination Bluetooth/Wi-Fi transceiver 36, or any other suitable and/or desirable transceiver that implements any suitable and/or desirable wireless protocol now known or hereinafter developed.

The particular manner in which files are stored in the first file set 8 and/or the second file set 10, however, is not to be construed in a limiting sense since it is envisioned that any suitable and/or desirable manner to input files into the first file set 8 and/or the second file set 10 can be utilized.

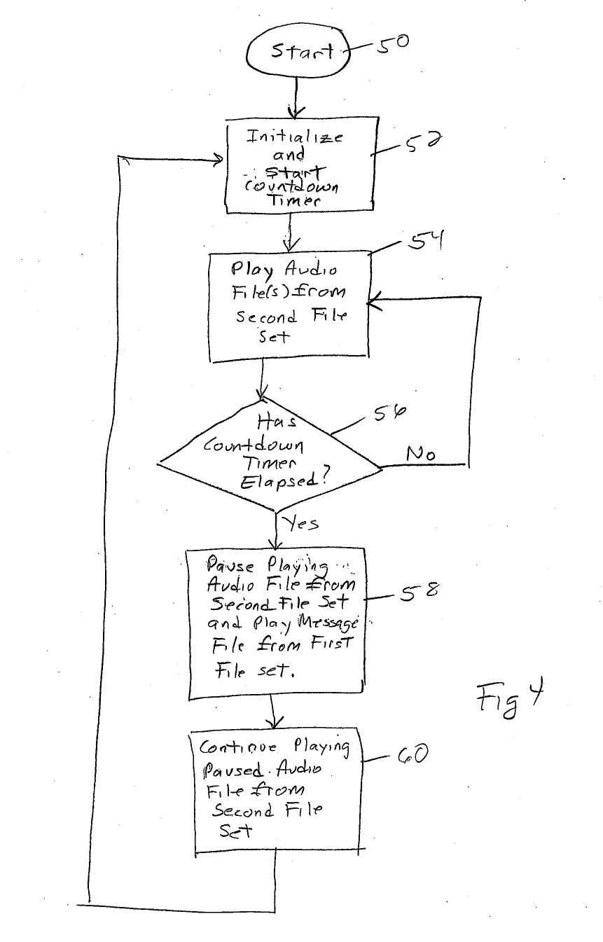

With reference to FIG. 4, and with continuing reference to all previous figures, a basic method of operation of device 2 will now be described. The method commences at start step 50. In response to pressing play/pause button 12-1, the method advances to step 52, wherein a countdown timer of controller 4 is initialized to a starting value corresponding to the time value displayed in timer display 32 and the countdown timer commences decrementing to zero at a frequency based on frequency of a clock signal output by timer 20, i.e., a system clock used by controller 4. At step 54, controller 4 causes one or more audio files from the second file set 10 to be played on speaker 26. In step 56, controller 4 queries whether the countdown timer has elapsed (decremented to zero). If not, steps 54 and 56 are repeated until the countdown timer has elapsed whereupon the method advances to step 58 where the audio file from the second file set 10 that is presently playing is paused and a message file from the first file set 8 is played on speaker 26. The method then advances to step 60, wherein the playing of the audio file that was paused in step 58 continues from the point where it was paused. Thereafter, method steps 52-60 are continuously repeated until the play/pause button 12-1 is pressed a second time, until the on/off switch 42 is switched to the off position thereby disconnecting electrical power from device 2, and/or until power supply 40 is drained or exhausted (i.e., insufficient electrical power is available to operate device 4).

Next, programming of the countdown time interval and of the message to be played from the first file set 8 will be described.

Assuming that first file set 8 includes two or more message files, e.g., messages A, B, . . . , the particular message from the first file set 8 to be played upon the countdown timer decrementing to zero can be selected via pressing message select button 12-4. In an example, controller 4 is programmed such that sequentially pressing message select button 12-4 sequentially advances the message file displayed in message file display 34 whereupon, in response to the countdown timer elapsing (decrementing to zero), the message associated with the message file displayed in message file display 34 will be played. In an example, first file set 8 can be limited by programming of controller 4 to storing a predetermined number of message files, in an example, 10 message files. In an example, suppose that message file A is presently displayed in message file display 34 and that it is desired to play message file B. Pressing and releasing message select button 12-4 a single time advances the message file displayed in message file display 34 from A to B and causes controller 4 to play message file B each time the countdown timer elapses (counts down or decrements to zero).

The duration or value of the countdown time interval displayed in timer display 32 to be counted down or decremented by the countdown timer can be programmed into controller 4 by selectively pressing minute button 12-5. In an example, timer display 32 can be a two-character display and controller 4 can be operative for incrementing timer display 32 in one minute increments in response to sequentially pressing minute button 12-5 and/or in response to pressing and holding minute button 12-5. In this example, timer display 32 can be incremented from one minute to 99 minutes, whereafter timer display 32 and the time utilized by the countdown timer rolls back to one minute and advances again in response to each press of minute button 12-5, or in response to continuously depressing minute button 12-5.

Also or alternatively to storing one or more message files in first file set 8 via a PC and input port 14, via a memory card, and/or via transceiver 36, one or more messages can be recorded in first file set 8 via microphone 18. More specifically, in an example, when it is desired to record a message into first file set 8, a user of device 2 initially selects the message file of first file set 8 in which to record the patient message. This is accomplished by pressing message select button 12-4 until a desired message file A, B, . . . is displayed in message file display 34. If the desired message file is already displayed in message file display 34, it would not be necessary to press the message select button 12-4. Next, when it is desired to record the message into the message file displayed on message file display 34, record button 12-3 is depressed and held while, simultaneously, the message is input (spoken or played) into microphone 18. Once recording of the message is complete, releasing record button 12-3 enters the message into the message file of first file set 8 displayed on message file display 34. In an example, the message can be entered in live (by a person speaking into microphone 18), remotely via playing the speaker of a telephone or smartphone into microphone 18, or via a pre-recorded audio message played into microphone 18.

The invention has been described with reference to an exemplary embodiment. Obvious modifications and alterations will occur to those skilled in the art upon reading and understanding the preceding detailed description. It is intended that the invention be construed as including all such modifications and alterations insofar as they come within the scope of the appended claims or the equivalents thereof.

The invention claimed is:

1. A method of operation of a programmable audio device comprising:
(a) initializing and starting a countdown timer;
(b) playing a stored audio file;
(c) determining if the countdown timer has elapsed and, if not, continue playing the stored audio file until the countdown timer elapses;
(d) in response to the countdown timer elapsing, pause playing the audio file and play a message file; and
(e) following step (d), continue playing the paused audio file.

2. The method of claim 1, wherein step (d) includes delaying the pause and playing the audio file until the end of the audio file.

3. The method of claim 1, further including repeating steps (a)-(e) at least once.

4. The method of claim 1, wherein the countdown timer elapses when the value of the countdown timer decrements to zero.
